(19) United States
(12) Patent Application Publication
(10) Pub. No.: US 2022/0300765 A1
(43) Pub. Date: Sep. 22, 2022

(54) HYPER-PARAMETER CONFIGURATION METHOD OF TIME SERIES FORECASTING MODEL

(71) Applicants: Inventec (Pudong) Technology Corporation, Shanghai (CN); INVENTEC CORPORATION, Taipei (TW)

(72) Inventors: Davide Burba, Taipei (TW); JONATHAN HANS SOESENO, Taipei (TW); Trista Pei-Chun CHEN, Taipei (TW)

(21) Appl. No.: 17/348,984

(22) Filed: Jun. 16, 2021

(30) Foreign Application Priority Data
Mar. 16, 2021 (CN) 202110282461.2

(51) Int. Cl. G06K 9/62; G06N 3/08

(52) U.S. Cl. CPC G06K 9/6257; G06K 9/6262; G06K 9/6228; G06N 3/08

(57) ABSTRACT

A hyper-parameter configuration method of time-series forecasting model comprises storing N datasets respectively corresponding to N products; determining a forecasting model; and performing a hyper-parameter searching procedure. The hyper-parameter searching procedure comprises generating M sets of hyper-parameters; applying each set of hyper-parameters to the forecasting model; training and validating the forecasting model respectively according to two strategies to generate two error arrays, wherein the two strategies selects the training dataset and the validation dataset from N datasets in different two data dimensions, performing a weighting computation or an ordering operation according to two weights and the two error arrays and searching for a target set of hyper-parameters, wherein two error values corresponding to the target set of hyper-parameters in the two error arrays are two relative minimums.

### CROSS-REFERENCE TO RELATED APPLICATIONS

This non-provisional application claims priority under 35 U.S.C. § 119(a) on Patent Application No(s). 2021102824612 filed in China on Mar. 16, 2021, the entire contents of which are hereby incorporated by reference.

### BACKGROUND

### 1. Technical Field

This disclosure relates to a hyper-parameter configuration method of a time series forecasting model based on machine learning.

### 2. Related Art

Artificial Intelligence (AI) has become a crucial part in our daily life. AI enables human capabilities in understanding, reasoning, planning, communication, and perception. Although AI is a powerful technology, developing AI models is no trivial matter since there would be a reality gap between the development and deployment stages. Failure to bridge this reality gap would yield false insights that cascade errors and escalate unwanted risks. Therefore, it is critical to ensure the model's performance.

Measuring or evaluating an AI model's performance is often associated with high accuracy. Therefore, it is natural for AI modelers to optimize this objective. To do so, AI modelers perform hyper-parameter tuning to achieve the best accuracy. During the development stage, hyper-parameter tuning is performed on the training and validation sets. However, such tuned AI model with this set of hyper-parameters could fail on the test set during the deployment stage. That is, there is a performance gap between the performances, often measured in accuracy, of the development and the deployment stages.

One of numerous AI's applications is to produce forecasts for multiple time-series data by a forecasting model. Time series is the quantities of changes of a certain phenomenon arranged in the order of time. The development trend of this phenomenon may be deduced from the time series, so the development direction and quantity of the phenomenon may be predicted. For example, one may use a forecasting model to forecast the daily temperatures of multiple cities, or use another forecasting model to forecast the customer demands of multiple products.

In order to predict multiple time-series, one can resort to a separate forecasting model, which can be a neural network model, for each of the time-series. However, given a large amount of time-series data to be predicted, this approach may not be feasible given its complexity and memory requirement for such large amount of forecasting models.

If a single forecasting model is adopted, such single forecasting model will take all these multiple times-series data into consideration. To utilize all these time-series data to train the forecasting model, the model may overfit the training data.

When a conventional single time-series forecasting model is applied to multiple time-series, the performance gap between the development and the deployment stages generally comes from two sources. Firstly, the model fails to generalize to different time frames. Secondly, the model, that is trained on one set of time-series data, fails to generalize to a different set of time-series. In other words, the conventional forecasting model cannot handle either unknown time frames, or unknown products.

### SUMMARY

According to one or more embodiment of the present disclosure, a hyper-parameter configuration method of time-series forecasting model comprising: storing N datasets respectively corresponding to N products by a storage device, wherein each of the datasets is a time-series; determining a forecasting model; and preforming a hyper-parameter searching procedure by a processor, wherein the hyper-parameter searching procedure comprises: generating M sets of hyper-parameters for the forecasting model by the processor; applying each of the M sets of hyper-parameters to the forecasting model by the processor; training the forecasting model applied with each of the M sets of hyper-parameters according to a first strategy and a second strategy respectively by the processor, wherein the first strategy and the second strategy respectively comprise performing a selection of a part of the N datasets as a training dataset according to two different data dimensions; validating the forecasting model applied with each of the M sets of hyper-parameters according to the first strategy and the second strategy to generate two error arrays by the processor, wherein the first strategy and the second strategy respectively comprise performing another selection of another part of the N datasets as a validation dataset according to the two different data dimensions, and each of the two error arrays has M error values; performing a weighting computation or a sorting operation according to a first weight, a second weight and the two error arrays by the processor; determining a target set of hyper-parameters according to the two error arrays by the processor, wherein the target set of hyper-parameters is one of the M sets of hyper-parameters, and the two error values corresponding to the target set of hyper-parameters in the two error arrays are two relative minimum values in the two error arrays; outputting the target set of hyper-parameters by the processor when the target set of hyper-parameters is determined; and increasing a value of M and performing the hyper-parameter searching procedure by the processor when the target set of hyper-parameters cannot be determined.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a flow chart of the hyper-parameter configuration method of a time-series forecasting model according to an embodiment of the present disclosure;

FIG. 2 is a detailed flow chart of the hyper-parameter searching procedure;

FIG. 3 is a schematic diagram of the first strategy and the second strategy;

FIG. 4 is a detailed flow chart of an embodiment of step S37 in FIG. 2; and

FIG. 5 is a detailed flow chart of another embodiment of step S37 in FIG. 2.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

We use an example to illustrate a situation adapted to the present disclosure: considering the task of developing an accurate forecasting model that aims to predict the sales of next 12 months over ten products. To successfully do that, the forecasting model needs to capture the temporal sales pattern within each product and the sales dynamics across products. A good forecasting model comprises a good set of hyper-parameters.

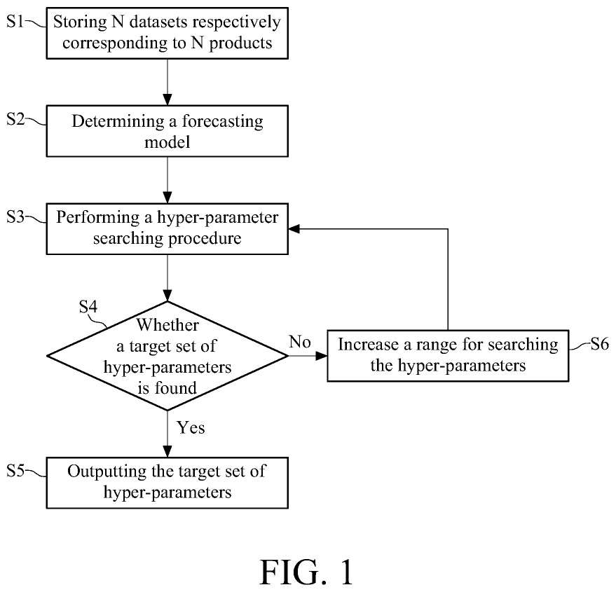

FIG. 1 is a flow chart of the hyper-parameter configuration method of a time-series forecasting model according to an embodiment of the present disclosure.

In step S1, a storage device stores N datasets respectively corresponding to N products, wherein each of the datasets is a time-series of a product. For example, the time-series is the monthly sales of the product over the past three years.

In step S2, a forecasting model is determined. In an embodiment of the present disclosure, the forecasting model is a long short-term memory (LSTM) model. LSTM is a variant of recurrent neural network (RNN). LSTM scales with large data volume and can take multiple variables as input which helps the forecasting model to solve the logistics problem. LSTM can also model long-term and short-term dependencies due to its forget and update mechanism. An embodiment of the present disclosure adopts LSTM as the time-series forecasting model.

Steps S3-S6 describe a flow for the processor to find a set of hyper-parameters suitable for the forecasting model of step S2.

In step S3, the processor performs a hyper-parameter searching procedure. In step S4, the processor determines whether a target set of hyper-parameters is found in step S3. If the determination result of step S4 is positive, step S5 is then performed to output the target set of hyper-parameters. On the other hand, if the determination result of step S4 is negative, step S6 is performed to increase a range for searching the hyper-parameters, and then step S3 is performed again.

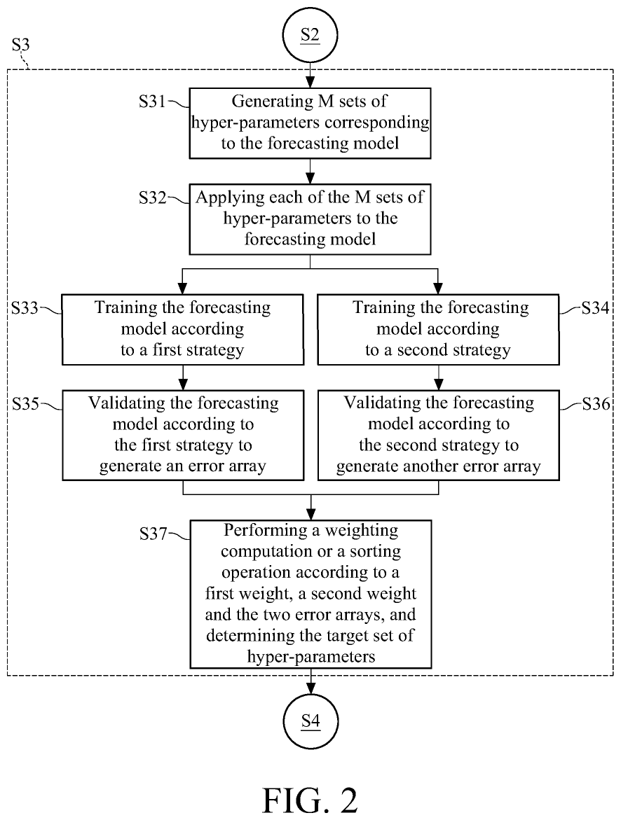

FIG. 2 is a detailed flow chart of the hyper-parameter searching procedure.

In step S31, the processor generates M sets of hyper-parameters corresponding to the forecasting model. M is a relatively large number such as 1000. In practice, the processor generates M sets of hyper-parameters randomly. Each set of hyper-parameters comprises a plurality of hyper-parameters. For example, hyper-parameters adopted by LSTM comprise a dropout rate of hidden layer's neurons, a kernel size, a number of layers of multilayer perceptron (MLP); and hyper-parameters adopted by light gradient boosting (Light GBM) comprise a number of leaves and a tree's depth.

In step S32, the processor applies each of the M sets of hyper-parameters to the forecasting model. Therefore, M forecasting models are generated in this step S32, and each of them has different configuration parameters.

In step S33 and step S34, the processor trains the forecasting model applied with each of the M sets of hyper-parameters according to a first strategy and a second strategy respectively. In step S35 and step S36, the processor validates the forecasting model applied with each of the M sets of hyper-parameters according to the first strategy and the second strategy to generate two error arrays. Specifically, the first strategy and the second strategy respectively comprise performing a selection of a part of the N datasets as a training dataset according to two different data dimensions. The first strategy and the second strategy respectively comprise performing another selection of another part of the N datasets as a validation dataset according to the two different data dimensions. The two different data dimensions comprise a data dimension of time-series and a data dimension of product.

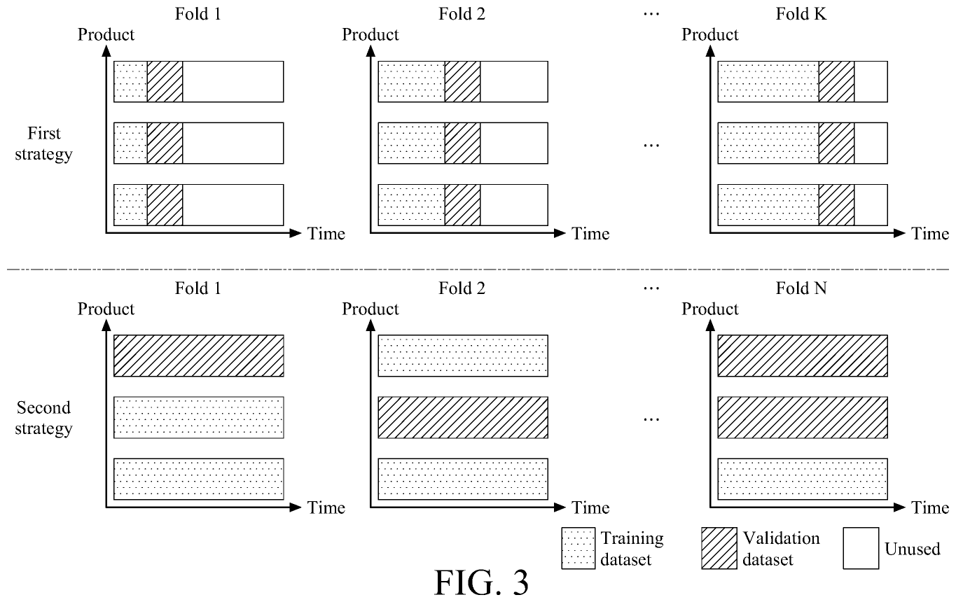

FIG. 3 is a schematic diagram of the first strategy and the second strategy. In order to capture the temporal sales pattern within each product and the sales dynamics across products, the present disclosure proposes two strategies of cross-validation as shown in FIG. 3, wherein the selection and the another selection of the first strategy respectively comprise performing the cross-validation in a time axis, the selection and the another selection of the second strategy respectively comprise performing the cross-validation in a product axis.

FIG. 3 illustrates three products as an example, wherein each rectangular represents one product, the dotted region represents the training dataset, the slashed region represents the validation data set, and the blank region represents the unused part of the original dataset. The selection and the another selection of the first strategy comprises a K-fold cross-validation in the data dimension of time-series as the horizontal axis shown in FIG. 3. The present disclosure does not limit the value of K. In the first strategy, an amount of data of the training dataset increases from fold 1 to fold K. For example, the amount of training data of fold 1 is the monthly sales in January, the amount of training data of fold 2 is the monthly sales in January and February, . . . , the amount of training data of fold 10 is the monthly sales from January to October. In the first strategy, the amount of data of the validation dataset is fixed from fold 1 to fold K, and the validation dataset is later than the training dataset in a time domain of the time-series. For example, the amount of the validation data of fold 1 is the monthly sales in February, the amount of the validation data of fold 2 is the monthly sales in March, . . . , the amount of the validation data of fold 10 is the monthly sales in November. In the first strategy, the amount of data of the training dataset in greater than or equal to the amount of data of the validation dataset. The forecasting model is configured to predict what comes right after the training time frame. Therefore, the validation time frame always comes right after the training time frame. It should be noticed that, the forecasting model may have high accuracy when a length of the forecasting time is equal to a length of the sampling time of the validation dataset. Overall, the present disclosure performs the cross-validation in the temporal axis with the first strategy, wherein the process has to conform with the “causality” constraint, that is, the training dataset cannot include data from the future. The validation dataset shall always be after the training set in time. For each fold, the present disclosure proposes selecting the training dataset from the original dataset in different time lengths.

The second strategy specially proposed by the present disclosure considers the data dimension of the product as the vertical axis shown in FIG. 3, that is, all kinds of products are divided into a training dataset and a validation dataset, and an N-fold cross-validation is performed. As shown in FIG. 3, each of the N folds comprises different combinations of training dataset and validation dataset of products. This is to simulate training for one set of products and to predict another set of unknown products. In other words, a forecasting model is trained, based on the associations between the existing products, to predict an association between other products and existing products. The present disclosure does not limit the value of N. In another example, assuming there are 12 products, the number of N may be set to 12, 6, 4, 3 or 2, that is, the factor of the number of products.

When the forecasting model well trained in step S33 and step S34 performs the N-fold cross-validation, the forecasting model generates an error (loss) in every fold. The error is the difference between the predicted value outputted by the forecasting model and the actual value in the validation data set. In step S35 and step S36, the errors of all N folds are summed to obtain a total error (hereinafter referred to as “error value”). Therefore, the M error values may be obtained by performing validation with the first strategy on M forecasting models, wherein the M error values form an error array; and M error values may be obtained by performing validation with the second strategy on M forecasting models, wherein the M error values form another error array. In short, two error arrays are obtained in step S35 and step S36, each of the two error arrays has M error values.

Please refer to step S37 in FIG. 2. In step S37, the processor performs a weighting computation or a sorting operation according to a first weight, a second weight and the two error arrays, and determines a target set of hyper-parameters according the two error arrays. The target set of hyper-parameters is one of the M sets of hyper-parameters, and the two error values corresponding to the target set of hyper-parameters in the two error arrays are two relative minimum values in the two error arrays.

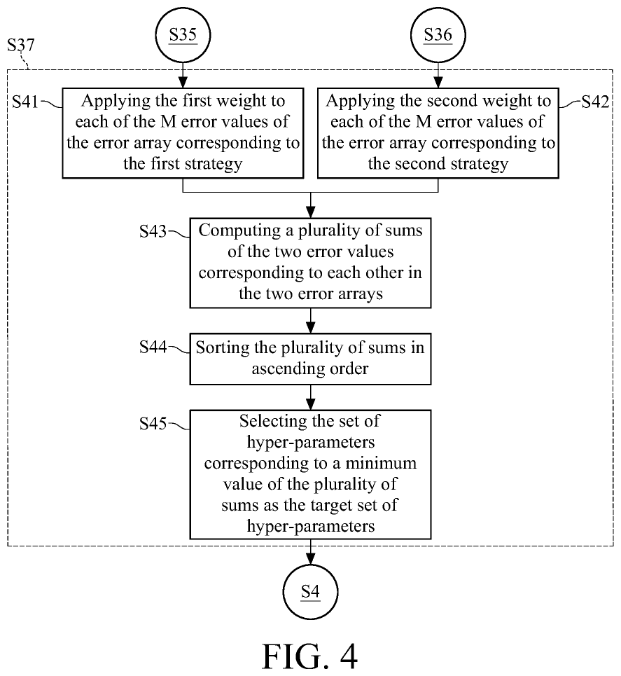

FIG. 4 is a detailed flow chart of an embodiment of step S37 in FIG. 2.

In step S41, the processor applies the first weight to each of the M error values of the error array corresponding to the first strategy. In step S42, the processor applies the second weight to each of the M error values of the error array corresponding to the second strategy. In step S43, the processor computes a plurality of sums of the two error values corresponding to each other in the two error arrays.

For better understanding, the present disclosure assumes the error array corresponding to the first strategy is [e₁¹ e₂¹ e₃¹ . . . e_{M}¹], the error array corresponding to the second strategy is [e₁² e₂² e₃² . . . e_{M}²], wherein eᵢ^{P} represents the i^{th} error value of the P^{th} strategy.

The present disclosure assumes the first weight is ω₁ and the second weight is ω₂. After performing the process of steps S41-S43, the present disclosure generates a new array [E₁ E₂ E₃ . . . E_{M}], which comprises M weighting error values, and Eᵢ=ω₁eᵢ¹+ω₂eᵢ².

Through the adjustments of the first weight and the second weight, the present disclosure may adjust the focus on the temporal prediction accuracy or the prediction accuracy for unknown products of the forecasting model, respectively.

In step S44, the processor sorts the plurality of sums in ascending order. Specifically, the processor arranges values from small to large according to E₁, E₂, E₃, . . . , E_{M}. In step S45, the processor selects the set of hyper-parameters corresponding to a minimum value of the plurality of sums as the target set of hyper-parameters. Specifically, the target set of hyper-parameters E_{target} satisfies E_{target}≤Eᵢ, i∈{1, 2, 3, . . . , M}. After the sorting operation of step S44, the target set of hyper-parameters E_{target} is the first element of the error array.

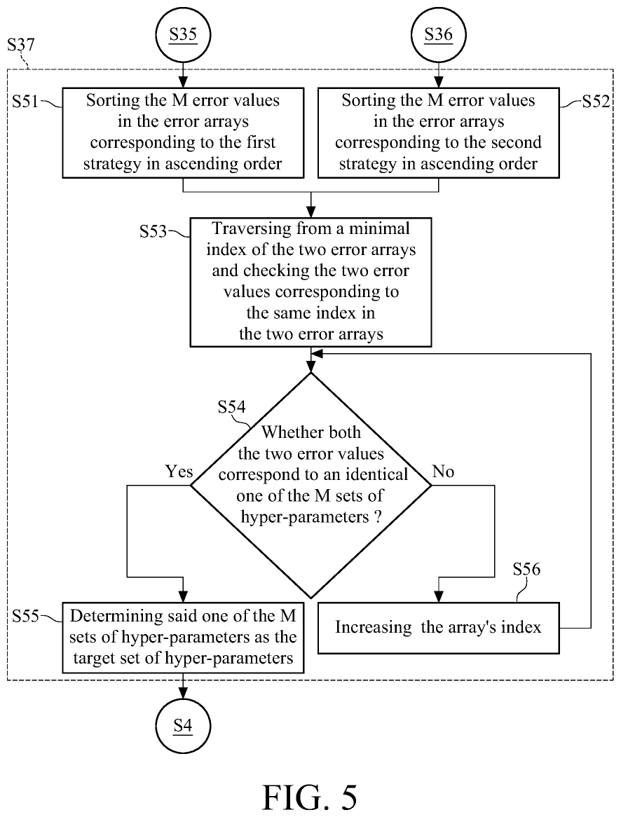

FIG. 5 is a detailed flow chart of another embodiment of step S37 in FIG. 2.

In step S51, the processor sorts the M error values in the error arrays corresponding to the first strategy in ascending order. In step S52, the processor sorts the M error values in the error arrays corresponding to the second strategy in ascending order. In step S53, the processor traverses from a minimal index of the two error arrays, and checks the two error values corresponding to the same index in the two error arrays. In step S54, the processor determines whether both the two error values correspond to an identical one of the M sets of hyper-parameters.

If the determination result of step S54 is positive, step S55 is then performed to determine said one of the M sets of hyper-parameters as the target set of hyper-parameters. In other words, when both the two error values correspond to the same one of the M sets of hyper-parameters, said one of the M sets of hyper-parameters is served as the target set of hyper-parameters. At this time, the determination result of step S4 in FIG. 1 is positive, and step S5 is the next step for outputting the target set of hyper-parameters.

If the determination result of step S54 is negative, step S56 is then performed. In step S56, the processor increases the array's index.

For better understanding, the following uses practical values to illustrate the process of step S51-S56, assuming the two error arrays corresponding to the first strategy and the second strategy are shown as Table 1.

TABLE 1

| | Hyper-parameter index | | | | | | | | | |
|---|---|---|---|---|---|---|---|---|---|---|
| | of the first strategy | | | | | | | | | |
| | 1 | 2 | 3 | 4 | 5 | 6 | 7 | 8 | 9 | 10 |
| Error value correspond- | 11 | 78 | 82 | 40 | 30 | 36 | 12 | 69 | 2 | 80 |
| ing to the first strategy | | | | | | | | | | |
| | Hyper-parameter index | | | | | | | | | |
| | of the second strategy | | | | | | | | | |
| | 1 | 2 | 3 | 4 | 5 | 6 | 7 | 8 | 9 | 10 |
| Error value correspond- | 4 | 73 | 49 | 27 | 93 | 68 | 5 | 54 | 32 | 25 |
| ing to the second strategy | | | | | | | | | | |

When the processor finishes step S51 and step S52, the result is shown as Table 2.

TABLE 2

| Index | 1 | 2 | 3 | 4 | 5 | 6 | 7 | 8 | 9 | 10 |
|---|---|---|---|---|---|---|---|---|---|---|
| Hyper-parameter index | 9 | 1 | 7 | 5 | 6 | 4 | 8 | 2 | 10 | 3 |
| of the first strategy | | | | | | | | | | |
| Error value correspond- | 2 | 11 | 12 | 30 | 36 | 40 | 69 | 78 | 80 | 82 |
| ing to the first strategy | | | | | | | | | | |
| Hyper-parameter index | 1 | 7 | 10 | 4 | 9 | 3 | 8 | 6 | 2 | 5 |
| of the second strategy | | | | | | | | | | |
| Error value correspond- | 4 | 5 | 25 | 27 | 32 | 49 | 54 | 68 | 73 | 93 |
| ing to the second strategy | | | | | | | | | | |

Please refer to the example as shown in Table 2. In step S53, the minimum index of the error array is “1”, so the processor first checks two error values “2” and “4” corresponding to the index “1”. The error value “2” corresponds to the 9^{th} set of hyper-parameters, and the error value “4” corresponds to the 1^{st} set of hyper-parameters.

In step S54, these two error values “2” and “4” do not correspond to the same set of hyper-parameters (9≠1), therefore, step S56 is performed next for increasing the array index from “1” to “2” and then the process returns to step S54. This loop process will be repeatedly performed until the index reaches to “7”. Both two error values “69” and “54” correspond to the 8^{th} set of hyper-parameters, therefore, step S55 is then performed and the target set of hyper-parameters is set to the 8^{th} set of hyper-parameters.

During the loop process of step S54 and step S56, it is possible that the processor has already traversed all the indices of the array without finding two error values corresponding to the same index correspond to the same set of hyper-parameters. At this time, the determination result of step S4 in FIG. 1 is negative, step S6 is then performed for increasing the search range of hyper-parameters, and the hyper-parameter search procedure of step S3 is then performed again. In an embodiment, the value of M can be increased and another M sets of hyper-parameters are generated. In another embodiment, only another new L sets of hyper-parameters are generated, and the process shown in FIG. 1 is performed with (L+M) sets of hyper-parameters.

To produce a single time-series forecasting model that takes all time-series data into consideration without overfitting, the present disclosure proposes a hyper-parameter configuration method of time-series forecasting model based on machine learning. A good forecasting model comprises a good set of hyper-parameters. The hyper-parameter searching procedure proposed in the present disclosure has two good cross-validation strategies, thereby generating a good set of hyper-parameters. The present disclosure proposes a hyper-parameter configuration method of time-series forecasting model on top of existing cross-validation techniques with generalization as the core concern. For this purpose, the present disclosure applies appropriate cross-validation techniques on in-class and out-class data points simultaneously to ensure the AI model generalizes well on both in-class and out-class cases.

In view of the above description, the proposed hyper-parameter configuration method of a time-series forecasting model is applicable to any machine-learning based time-series forecasting model. The present disclosure captures the temporal sales pattern within each product and captures the dynamics across products.

What is claimed is:

1. A hyper-parameter configuration method of time-series forecasting model comprising:
storing N datasets respectively corresponding to N products by a storage device, wherein each of the datasets is a time-series;
determining a forecasting model; and
preforming a hyper-parameter searching procedure by a processor, wherein the hyper-parameter searching procedure comprises:
generating M sets of hyper-parameters for the forecasting model by the processor;
applying each of the M sets of hyper-parameters to the forecasting model by the processor;
training the forecasting model applied with each of the M sets of hyper-parameters according to a first strategy and a second strategy respectively by the processor, wherein the first strategy and the second strategy respectively comprise performing a selection of a part of the N datasets as a training dataset according to two different data dimensions;
validating the forecasting model applied with each of the M sets of hyper-parameters according to the first strategy and the second strategy to generate two error arrays by the processor, wherein the first strategy and the second strategy respectively comprise performing another selection of another part of the N datasets as a validation dataset according to the two different data dimensions, and each of the two error arrays has M error values;
performing a weighting computation or a sorting operation according to a first weight, a second weight and the two error arrays by the processor;
determining a target set of hyper-parameters according to the two error arrays by the processor, wherein the target set of hyper-parameters is one of the M sets of hyper-parameters, and the two error values corresponding to the target set of hyper-parameters in the two error arrays are two relative minimum values in the two error arrays;
outputting the target set of hyper-parameters by the processor when the target set of hyper-parameters is determined; and
increasing a value of M and performing the hyper-parameter searching procedure by the processor when the target set of hyper-parameters cannot be determined.

2. The hyper-parameter configuration method of time-series forecasting model of claim 1, wherein the forecasting model is a long short-term memory model.

3. The hyper-parameter configuration method of time-series forecasting model of claim 1, wherein the selection and the another selection of the first strategy respectively comprise a K-fold cross-validation in a data dimension of time-series, and the selection and the another selection of the second strategy respectively comprise a N-fold cross-validation in a data dimension of product.

4. The hyper-parameter configuration method of time-series forecasting model of claim 3, wherein in the first strategy, an amount of data of the training dataset increases from fold 1 to fold K, an amount of data of the validation dataset is fixed from fold 1 to fold K, and the validation dataset is later than the training dataset in a time domain of the time-series.

5. The hyper-parameter configuration method of time-series forecasting model of claim 1,
wherein performing the weighting computation or the sorting operation according to the first weight, the second weight and the two error arrays by the processor comprises:
applying the first weight to each of the M error values of the error array corresponding to the first strategy by the processor;
applying the second weight to each of the M error values of the error array corresponding to the second strategy by the processor;
computing a plurality of sums of the two error values corresponding to each other in the two error arrays;
sorting the plurality of sums in ascending order; and
selecting the set of hyper-parameters corresponding to a minimum value of the plurality of sums as the target set of hyper-parameters.

6. The hyper-parameter configuration method of time-series forecasting model of claim 1,
wherein performing the weighting computation or the sorting operation according to the first weight, the second weight and the two error arrays by the processor comprises:
sorting each of the M error values in the error arrays corresponding to the first strategy in ascending order by the processor; and
sorting each of the M error values in the error arrays corresponding to the second strategy in ascending order by the processor;
wherein determining the target set of hyper-parameters from the two error arrays by the processor comprises:
traversing from a minimal index of the two error arrays, checking the two error values corresponding to the same index in the two error arrays; and
when both the two error values correspond to an identical one of the M sets of hyper-parameters, using said one of the M sets of hyper-parameters as the target set of hyper-parameters.
